(19) United States
(12) Patent Application Publication
(10) Pub. No.: US 2006/0209864 A1
(43) Pub. Date: Sep. 21, 2006

(54) Separate control line for maintenance of repeaters of a digital subscriber line

(76) Inventor: Roger Kerkhof, Udenhout (NL)

Correspondence Address: JENKENS & GILCHRIST, PC, 1445 ROSS AVENUE, SUITE 3200, DALLAS, TX, 75202, US

(21) Appl. No.: 10/473,639

(22) PCT Filed: Mar. 28, 2001
(86) PCT No.: PCT/NL01/00255

§ 371 Date: Jan. 20, 2004

(51) Int. Cl. H04L 12/56

(52) U.S. Cl. 370/419; 370/252

(57) ABSTRACT

Digital subscriber line (DSL) system comprising a digital subscriber line access multiplexer (DSLAM, 20) having a line trunk unit (LTU, 13), a repeater container (23) containing a repeater (16) and a customer premises equipment (CPE, 11) having a network terminating unit (NTU, 15) in which the repeater (16) connects a line trunk unit (13) to a network terminating unit (15) through respective lengths (18, 19) of a digital subscriber line and in which both the digital subscriber line access multiplexer (20) and the repeater container (23) comprise an operation and maintenance unit (OMU, 21, 24) which are connected to each other by a line (25) which is separate from the digital subscriber line for controlling the operation and maintenance of the repeater (16) or repeaters (16) of the repeater container (23) from the digital subscriber line access multiplexer (20).

The invention relates to a digital subscriber line (DSL) system as described in the preamble of claim 1.

A digital subscriber line system of such type is known from practice. There are several subtypes of a communication type which is known as “Digital Subscriber Line” (DSL) between a central unit or Digital Subscriber Line Access Multiplexer (DSLAM) having a Line Trunk Unit (LTU) and a subscriber unit or Customer Premises Equipment (CPE) having a network terminating unit (NTU). Communication through digital subscriber line comprises the possibility to be used with twisted copper wire pairs which are presently commonly used for voice baseband communication. Asynchronous Digital Subscriber Line (ADSL) communication allows a download (towards the subscriber) bitrate of 8 Mbit/s and an upload (towards the central unit) bitrate of 1 Mbit/s at the same time through a single copper wire pair. Depending on an error rate occurring during communication the bitrates are adapted below said figures until an acceptable error rate is obtained. In the central unit and in the subscriber unit filters are used to combine or separate baseband voice signals and higher frequency digital data signals. High bitrate Digital Subscriber Line (HDSL) communication allows a bitrate in both the download and upload directions of 2 Mbit/s over two respective copper wire pairs. Said bitrate of 2 Mbit/s is fixed, that is, independent from an error rate occurring during communication. HDSL can be called symmetric DSL because of the identical bitrates in both directions. Other symmetric DSL communication types are Symmetrical single pair Digital Subscriber Line (SDSL) and Symmetrical single pair High bitrate Digital Subscriber Line (SHDSL). All types of digital subscriber line communication together are indicated by xDSL.

The copper pairs used for XDSL are pairs of a huge cable bundle of many (for example 80) pairs which are used for several types of communication, such as voice and ISDN and, recently, xDSL. In particular ISDN and xDSL communications over neighbouring copper pairs carrying high frequency signals may adversely effect each other. This may require the use of repeaters in copper pairs for symmetric or fixed bitrate digital subscriber line communication (HDSL, SHDSL and SDSL) exceeding specific error rates or a specific distance between the central unit and the subscriber unit. Such distance may be for example 3 km. For this reason a repeater container containing several repeaters is used with one repeater serving a single subscriber line. Usually the repeater container is buried. The repeaters are managed for operations and maintenance from the central unit through the same copper pair which they are serving, thus using the same frequencies as used for the proper data and voice signals between the central unit and the subscriber. Such type of management can be called in-band management. In-band management has several disadvantages. If a repeater fails it is almost impossible to detect the problem and to solve it from the central unit. It may even require to dig up the repeater container for a local check. This of course is very time consuming and expensive. A repeater may malfunction for several reasons, some of which could be solved by downloading some control data or alternative software into the repeater. However, a failing repeater may not enable such downloading. In addition, though a repeater may seem to fail, in fact it could be working well but one or both subscriber line lengths to which it is connected is or are causing problems. The repeater and a subscriber line length may even both cause problems. Under circumstances it is not possible to detect from the central unit which of those are causing problems, making it impossible to choose and use a proper method for solving the problems from the central unit. Again this may require digging up the repeater container for a check of the repeater in question and the line lengths connected therewith from the container.

It is an object of the invention to solve the drawbacks of the prior art digital subscriber line system and to increase the quality of service.

To that end a digital subscriber line system according to claim 1 is provided by the invention.

The system provided by the invention provides out-band management of operations and maintenance of several repeaters contained in the repeater container, that is apart from the voice signals and data signals going through the repeaters, which makes said management resistant against influences from such signals and malfunction of one or more repeaters. Communication between the operations and maintenance units may need the voice baseband only, so that the copper pair connecting the operations and maintenance units may be any of the bundle it is part of in view of possibly adverse influence from other pairs of the bundle.

The invention also provides a method according to claim 6.

The invention will be described below with reference to the enclosed drawings, in which:

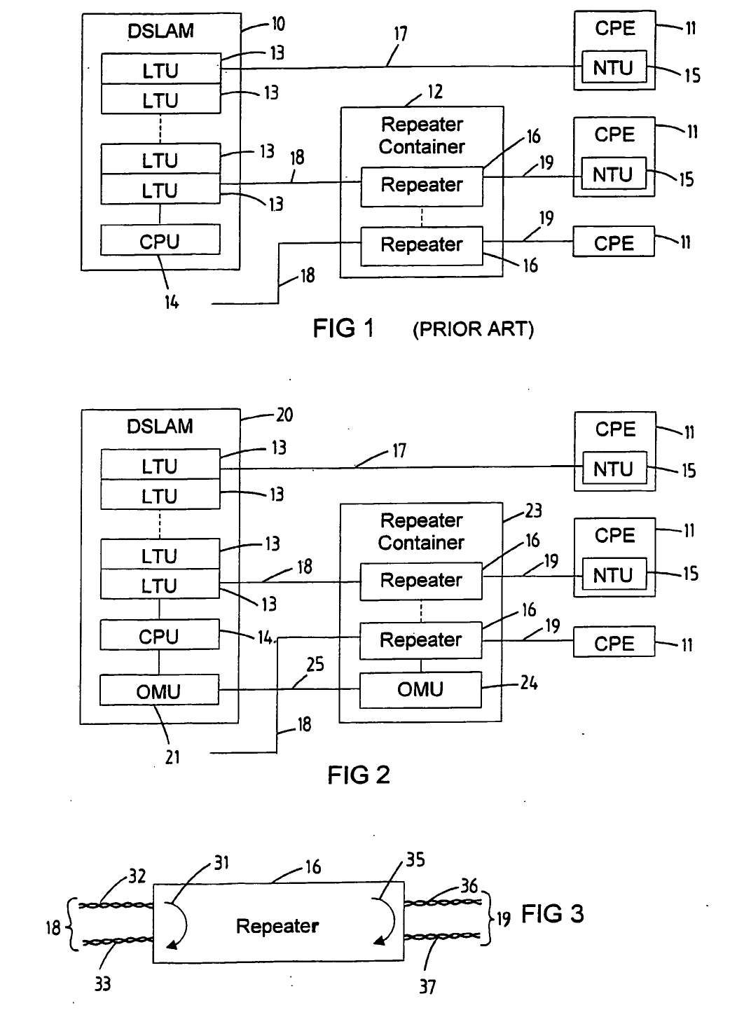

FIG. 1 shows a diagram of a digital subscriber line system according to the prior art;

FIG. 2 shows a diagram of a digital subscriber line system according to the invention; and

FIG. 3 shows a diagram of a repeater for exemplifying a checking operation thereof.

The diagram of the prior art digital subscriber line system shown in FIG. 1 comprises a digital subscriber line access multiplexer (DSLAM) 10, one or more customer premises equipment (CPE) 11 and a repeater container 12.

The digital subscriber line access multiplexer 10 comprises for each digital subscriber line it is serving a line trunk unit (LTU) 13. The digital subscriber line access multiplexer 10 further comprises a central processing unit (CPU) 14 which controls the operation of the line trunk units 13.

The customer premises equipment 11 comprises a network terminating unit (NTU) 15.

The repeater container 12 contains one or more repeaters or repeater units 16.

Dependent on an error rate a line trunk unit 13 can be connected directly to a network terminating unit 15 of a customer premises equipment 11 by a digital subscriber line 17, which, dependent on the digital subscriber line type, may consist of one or two twisted copper wire pairs. If required because of the error rate or distances between them a line trunk unit 13 may be connected to a network terminating unit 14 through a repeater 16 by respective digital subscriber line lengths 18, 19 respectively. As indicated with the lower subscriber line length 18 in FIG. 1 a repeater container 12 may serve digital subscriber lines connected to different digital subscriber line access multiplexers 10, possibly of different central units.

An acceptable length of a digital subscriber line 17 in which no repeater 16 is arranged is, for example, 3 km. Then, the digital subscriber line lengths 18, 19 which have a repeater 16 connected between them are also about 3 km at most.

Operation and maintenance of each repeater 16 is carried out by the central processing unit 14 of the digital subscriber line access multiplexer 10 by communication over the digital subscriber line length 18 to which the repeater 16 and the associated line trunk unit 13 are connected. In case of malfunction of a repeater 16 it will not always be possible to detect whether a communication problem detected at the side of the digital subscriber line access multiplexer 10 is caused by failing of the digital subscriber line lengths 18 and 19 or the repeater 16. In addition, the data transferred for the operation and maintenance control of the repeater 16 by the central processing unit 14 may be disturbed by signals carried over other copper wire pairs than those of line lengths 18, 19 and, dependent on the quality of communication, disturbed by signals supplied by the line trunk unit 13 to digital subscriber line length 18 or by the network terminating unit 15 of the associated customer premises equipment 11 to digital subscriber line length 19. This makes proper analysis of a communication path comprising a repeater 16 and digital subscriber line lengths 18 and 19 difficult, if not impossible. In addition, it may prevent software being downloaded from the digital subscriber line access multiplexer 10 to cure any of said problems, for example by updating software contained in the repeater 16 for its operation and maintenance.

The diagram of the digital subscriber line system according to the invention shown in FIG. 2 differs from the system shown in FIG. 1 by that the digital subscriber line access multiplexer 20 of FIG. 2 comprises in addition with respect to multiplexer 10 of FIG. 1 a first operations and maintenance unit (OMU) 21 and in that the repeater container 23 of FIG. 2 comprises in addition with respect to container 12 of FIG. 1 a second operations and maintenance unit (OMU) 24. The first operations and maintenance unit 21 is connected to the central processing unit 14. The second operations and maintenance unit 24 is connected to one or more repeaters 16 of the repeater container 23. The first and second operations and maintenance units 21, 24 are connected to each other by a copper wire pair 25 which is intended to carry control data signals for use by the operations and maintenance units 21, 24 only. The remaining components of the systems of FIG. 1 and 2 may basically be identical.

With the system shown in FIG. 2 analysis of the digital subscriber line lengths 18, 19 and the repeaters 16 is possible with very little chance of being disturbed by signals originating from other copper wire pairs which may be in use for a low speed connection over longer distance. Such analysis may even be carried out frequently, more often then with the system of FIG. 1, without taking proper data transfer capacity from the digital subscriber lines 18, 19 which the repeaters 16 are serving. Software can be downloaded from the first operations and maintenance unit 21 safely over copper wire pair 25 to the second operations and maintenance unit 24, possibly for updating its software for the operation and maintenance of the repeaters 16.

As shown diagrammatically in FIG. 3 the operations and maintenance unit 24 of a repeater container 23 may control a repeater 16 such that it makes a short connection, indicated by arrow 31 between two copper wire pairs 32, 33 of a digital subscriber line length 18 as close as possible to terminals of the repeater 16 to which said pairs 32, 33 are connected. Similarly, the operations and maintenance unit 24 of the repeater container 23 may make a short connection, indicated by arrow 35 between copper wire pairs 36, 37 of the other digital subscriber line length 19 as close as possible to terminals of the repeater 16 to which said pairs 36 and 37 are connected. By selectively applying such short connections 31, 35 it is possible to identify which of the digital subscriber line lengths 18, 19 or the repeater 16 is possibly malfunctioning. With the prior art system shown in FIG. 1 making such short connection 31 was impossible to make if the digital subscriber line length 18 or the repeater 16 itself failed either physically or by distortion of the signals which were carried. The same applies for the possibility to monitor failing of a remote power feeding the repeaters 16 of the repeater container 23.

In case that one digital subscriber line length 18, 19 fails, for example if it is physically disrupted, a loss of incoming signal (LIS) or loss of outgoing signal (LOS) can be generated by the operations and maintenance unit 24 of the repeater container 23 and then transmitted to the operations and maintenance unit 21 of the digital subscriber line access multiplexer 20 to take adequate action.

It is observed that with the prior art system shown in FIG. 1 it was only possible to detect failure of line length 19 or a combination of line lengths 18 and 19. With the system according to the invention it is possible to monitor and manage each line length 18, 19 independent from each other.

In addition it is observed that the invention can be applied also for a series connection of several line lengths (each at most 3 km, for example) and repeaters 16 of different container repeaters 23 in between. The same applies for a series connection of control lines and operations and maintenance units 24 of different container repeaters 23. This will still allow monitoring and causing any failures which were manageable in a simple system as illustrated in FIG. 2. This would be virtually impossible with a prior system having series connections of line lengths and repeaters in between.

1. Digital subscriber line system (DSL) comprising a digital subscriber line access multiplexer (DSLAM, 20) having a line trunk unit (LTU, 13), a repeater container (23), which contains a repeater (16) and a customer premises equipment (CPE, 11) having a network terminating unit (NTU, 15), in which lengths (18, 19) of a subscriber line connect the repeater to the line trunk unit (LTU, 13) and to the network terminating unit (NTU, 15) respectively, characterized in that the digital line access multiplexer (DSLAM, 20) comprises a first operations and maintenance unit (OMU, 21) and the repeater container (23) comprises a second operations and maintenance unit (OMU, 24) which is connected to the repeater (16), the first and second operations and maintenance units are connected by a control line (25) which is apart from the digital subscriber line, and the operations and maintenance units being suitable to operate and maintain the repeater in co-operation through control line (25).

2. Digital subscriber line system according to claim 1, characterized in that the control line (25) is of a type of a length of subscriber line.

3. Digital subscriber line system according to claim 1 or 2, characterized in that the line trunk unit (13) and the network terminating unit (15) are connected by a series of line lengths and repeaters (16) of different repeater containers (23) in between, and the second operations and maintenance units (24) of the different repeater containers are connected to at least one first operations and maintenance unit (21) of the digital subscriber line access multiplexer (20).

4. Digital subscriber line system according to claim 3, characterized in that the second operations and maintenance units (24) are connected to the at least one first operations and maintenance unit (21) by individual control lines (25).

5. Digital subscriber line system according to claim 3, characterized in that the second operations and maintenance units (24) are connected in series and to one first operations and maintenance unit (21) by control lines (25) in between.

6. Method for operating and managing a repeater (16) for repeating a digital subscriber line signal which is supplied to it and which is communicated through it between a digital subscriber line access multiplexer (20) and a customer premises equipment (CPE, 11), in which control signals to operate and manage the repeater (16) are communicated between the repeater (16) and a processing unit (14) of the multiplexer (20), characterized in that control signals from and to the multiplexer (20) are communicated over a communication path which is distinct from a communication path for the digital subscriber line signal.

7. Method according to claim 6, characterized in that the processing unit (14) delegates generating, transmitting, receiving and processing of control signals to a first operations and managing unit (21) of the multiplexer (20).

8. Method according to claim 6 or 7, characterized in that the repeater (16) delegates generating, transmitting, receiving and processing of control signals to a second operations and managing unit (24).

9. Method according to one of the claims 6-8, characterized in that control signals from and to the multiplexer (20) and a plurality of the repeaters (16) are communicated over different communication paths between the multiplexer (20) and each repeater (16) respectively.

10. Method according to claim 9, characterized in that the control signals to and from different ones of the repeaters are communicated to and from the multiplexer (20) over a common communication path.
